(19) United States
(12) Patent Application Publication
(10) Pub. No.: US 2014/0258158 A1
(43) Pub. Date: Sep. 11, 2014

(54) SYSTEM FOR RECORDING AND BROADCASTING MESSAGES TO SOCIAL NETWORKS, WEB, BLOG SPACES AND QUICK RESPONSE CODES

(71) Applicant: Norman Jay Levy, Brookville, NY (US)

(72) Inventor: Norman Jay Levy, Brookville, NY (US)

(21) Appl. No.: 14/269,864

(22) Filed: May 5, 2014

Related U.S. Application Data
(63) Continuation of application No. 13/462,247, filed on May 2, 2012.

(51) Int. Cl. H04L 12/58; G06Q 50/00

(52) U.S. Cl. CPC H04L 51/10; G06Q 50/01
USPC 705/319; 709/206

(57) ABSTRACT

This invention allows users to record audio or video messages from a variety of sources and automatically distribute them to various websites. Additionally this invention automatically designates a quick response code, for each message, which links to a uniform resource locator for the recorded message so that the quick response code can be placed on printed media and scanned to access the recorded message. The uniform resource locator, associated with the quick response code can be prescheduled to automatically change based on a time or date.

### CONTINUATION APPLICATIONS

This application is a continuation of application Ser. No. 13/462,247 filed on May 2, 2012, now abandoned, which claimed the benefit of a Provisional Patent Application No. 61/518,441 filed on May 5, 2011, now abandoned, entitled “System for Recording and Broadcasting Audio Messages to Social Networks, Web and Blog Spaces”, naming inventor as Norm Levy titled “System for Recording and Broadcasting Audio Messages to Social Networks, Web and Blog Spaces”, naming inventor as Norm Levy.

### BACKGROUND OF THE INVENTION

1. Field of the Invention

The present invention relates to a system for recording and broadcasting audio messages in a computer network environment and more specifically, to a system for recording and broadcasting audio messages to social networks, web and blog spaces.

2. Description of the Background Art

This invention relates generally to the field of distributing audio messages over the internet and accessible in print, particularly in a situation where an individual wants to record an audio message from their phone, smart phone, tablet or computer, and they would like the audio message to upload to the internet and automatically post to their accounts on various social networking sites.

Social networks such as Facebook and Twitter have become very popular. These social networks allow users to update their status or send mass text based messages to users that “follow” their account from computers or mobile devices. Text based messages are very useful for getting information across but less useful in expressing things like sarcasm or emotions. People who use text based messaging have developed acronyms and macros to reflect emotions like laughter. While acronyms or macros can denote the writers emotions at the time, it does very little to express in real terms the person's emotions that they are trying to express. Additionally acronyms and macros are insufficient to express emotional subtleties.

Most social networks do not have convenient ways to monetize your instant messages or to sell personalized messages. There is a need for celebrities and individuals who are popular on social networks to be able to easily monetize their instant message and sell personalized messages. Social network users need a way to record audio messages from a smart phone, computer, tablet or any telephone to be automatically distributed to social networks and other websites. Additionally

For example, U.S. Pat. No. 7,472,175 discloses a system for creating and posting media for sharing on a communication network issued in 2008 to Bartholomew. U.S. Pat. No. 7,197,544 discloses a voice and video greeting system for personal advertisement and method issued in 2007 to Wang. None of the known methods audio recording and distribution allow a user to record audio from either a phone, smart phone, tablet or computer and automatically distribute it to user selected social networks and websites. Nor do these known methods for recording and distributing audio messages include a method for selling the recorded audio messages.

Although these prior art patents do disclose methods for recording and distributing recorded audio, they fail to disclose a way to easily record these messages from a wide variety of devices and automatically distributing these recorded messages to social media networks, and websites.

The present invention solves this problem. The development of this invention was brought about from the necessity to be able to record audio messages while on the go or without the aid of a computer or smart phone. There was a need to easily and automatically distribute these recorded messages to websites and social media.

Additionally this invention allows users to automatically distribute the recorded audio message to a website that can be accessed with a quick response (QR) code. The user is able to have the audio recording submitted to a website address that already had a QR code referenced to it or the user may be given a new QR code for each audio message. Additionally changes to the uniform resource locator (URL) that the QR code is directed to may be prescheduled to change at specific times or dates.

Prior to this invention people who wanted to record an audio message from a mobile device, phone or computer and distributing it to various websites or a QR code would be required to perform several steps, in order to successfully distribute the recorded message social networks or websites. Also the audio recording can be immediately accessed by scanning an associated QR code.

### SUMMARY OF THE INVENTION

The object of the present invention is to provide a way to record “Shout” messages from a variety of devices including but not limited to a phone, a smart phone, a tablet and a computer. A “Shout” is defined as an audio or video message. The recorded Shout is then automatically distributed to social network sites and other websites, additionally the audio recording becomes automatically accessible by scanning an associated QR code on traditional media including but not limited to printed materials, bill boards, etc. The present invention may find utility among users of social media networks, blog users, anyone who would like to post an audio recording to a website and anyone who would like to listen to a automatically distributed message via a QR code. Additionally the present invention assigns each recorded audio message a quick response (QR) code, or two dimensional barcode. The present invention also discloses a system for automatically updating the URL associated with the QR code.

The invention is not limited to the above-described embodiments, and various changes are possible without departing from the principles set forth herein. Furthermore, the embodiments include the invention at various stages, and various inventions can be extracted by properly combining multiple disclosed constructional requirements. There are many applications of this method.

The present invention solves problems of prior art by allowing the user record audio message and automatically post them to websites and social media networks.

### BRIEF DESCRIPTION OF THE DRAWINGS

Preferred embodiments of the invention are described below with reference to the following accompanying drawings.

FIG. 1. is a diagram of the page people see before they login as a user.

FIG. 2. is a diagram of the page where people can register to become users.

FIG. 3. is a diagram of the connections page, where users can change some settings and create connect social media websites to their ShoutOmatic account.

FIG. 4. is a diagram of the account settings page, this allows users to change certain account settings.

FIG. 5. is a diagram of the password page, which allows users to change their password.

FIG. 6. is a diagram of the profile page, which allows users to change their profile.

FIG. 7. is a diagram of the notices page, which allows users to change their notices settings.

FIG. 8. is a diagram of the commerce page, which allows users to change their commerce settings.

FIGS. 9a, 9b, and 9c. are diagrams of the “home tab”, illustrating the functions available under this tab.

FIG. 10. is a diagram of the home page, that a user sees when they are logged in.

FIG. 11. is a diagram of the inbox, showing direct shouts that other users have sent being received in the logged in users inbox.

FIG. 12. is a diagram illustrating a page containing a shout seller's pending paid shouts.

FIGS. 13, 13a, 13b, and 13c. are diagrams illustrating a page with share links under each shout.

FIG. 14. is a diagram illustrating a user's profile page.

FIG. 15. is a diagram of a page illustrating the find people page.

FIG. 16. is a diagram of a page illustrating the help pages.

FIG. 17. is a diagram of the shout market page.

FIG. 18. is a diagram of a page illustrating instant shout's available for immediate purchase and download.

FIG. 19. is a diagram illustrating what instant shouts look like from the shout seller's perspective.

FIG. 20. is a diagram illustrating the ShoutOmatic Facebook application.

FIG. 21. is a diagram illustrating the ShoutOmatic iPhone application.

### DETAILED DESCRIPTION OF THE PREFERRED EMBODIMENTS

The following description is presented to enable one of ordinary skill in the art to make and use the invention and is provided in the context of a patent application and it's requirements. Various modifications to the preferred embodiments will be readily apparent to those skilled in the art and the generic principles herein may be applied to other embodiments. Thus, the present invention is not intended to be limited to the embodiment shown but is to be accorded the widest scope consistent with the principles and features described herein. ShoutOmatic is defined as the website and system for recording and broadcasting messages. ShoutOmatic application is defined as a piece of software which facilitates the recording and broadcasting of messages.

The present invention records analog phoned-in audio messages and broadcasts them in digital formats to social networks, web sites, blog spaces and is made available via a QR code to any printed media or dynamic media. Printed media means any media format that can be printed on such as a paper, cardboard, billboards, plastic, metal, silicone, fabric, glass, polymer, composite or other material known to a person having ordinary skill in the art that could be printed to. Dynamic media means a media such as the image in a television screen, computer monitor, projected screen, lcd screen, plasma screen, projection screen, holographic projection or other media known to a person having ordinary skill in the art which has the ability display an image and the ability to change. Additionally the present invention is capable of recording an audio message in a digital format using a computer, smartphone or similar device known to a person having ordinary skill in the art. As will be discussed in further detail herein, the present invention allows the user to phone-in digital audio Voice Twitter tweets and Facebook status updates. The user may record a Shout on the ShoutOmatic website or using the ShoutOmatic “App”, if available for their style phone or tablet computer, on their cellular phone to record their message to be distributed to Twitter, Facebook, or other enabled social networks. Additionally the recorded message becomes available via an associated QR code to any printed media or dynamic media.

1. In the user's ShoutOmatic “settings”, the user links the phone/cell number he or she will be calling “Shouts” in from. Additionally the user can choose to setup an identification number and pin number to link with the users account so that they can call from any phone and still have the recorded messages posted to their account.

2. Simply call our 717-746-8812 (SHOUT-12) Hotline and the user's Voice message automatically Posts to the user's ShoutOmatic, Twitter and Facebook feeds.

In a preferred embodiment, the analog audio transmission is received into a pbx phone data system. The analog audio is converted to several digital audio format files. The caller ID is accessed to identify who phoned the “Shout” message in to the system. The audio file formats are then routed to the appropriate social networks; ShoutOmatic, Twitter, Facebook, or other enabled social networks as well as the user's Shout Player widget that gets posted to any web site and/or blog. Additionally it is possible for a user to call in from any phone and enter a user specified pin code allowing them to post to their account. Accordingly, in an embodiment of the present invention, there is provided a system which allows a user to record and broadcast “audible status updates” (Shouts) so user's actual voice can be heard within the user's Twitter, Facebook, other enabled social networks feeds as well as all “social spaces”, blogs and web sites. Additionally the Shouts may be assessable by scanning an associated QR code on a printed media or dynamic media. “Social spaces” refers to any website area where a user is able to post the Shout Player widget. The Shout Player widget is defined as embedded html style code that when placed into a webpage's code allows anyone to listen to or view a Shout. The present invention also discloses a system for automatically updating QR code links. This automatic updating of QR codes can be scheduled temporally based or calendar based. Temporally based means based on the numeric time of day. A user may set different links which would automatically change the QR code's destination URL based on time for example a user might set different codes for 10:00 am, 1:00 pm, or 6:00 pm. This is completely customizable based on the user's preselected time it is customizable down to the minute. Additionally a user may set different links for the QR code to automatically change based on the day of the week e.g. a link could be set for every Wednesday. A user could also set different links for a QR code based on the day of the month e.g. a link could be set for the second Friday of every month. A user could also set a different links for a QR code based on the calendar date e.g. a link could be set for Apr. 21, 2012.

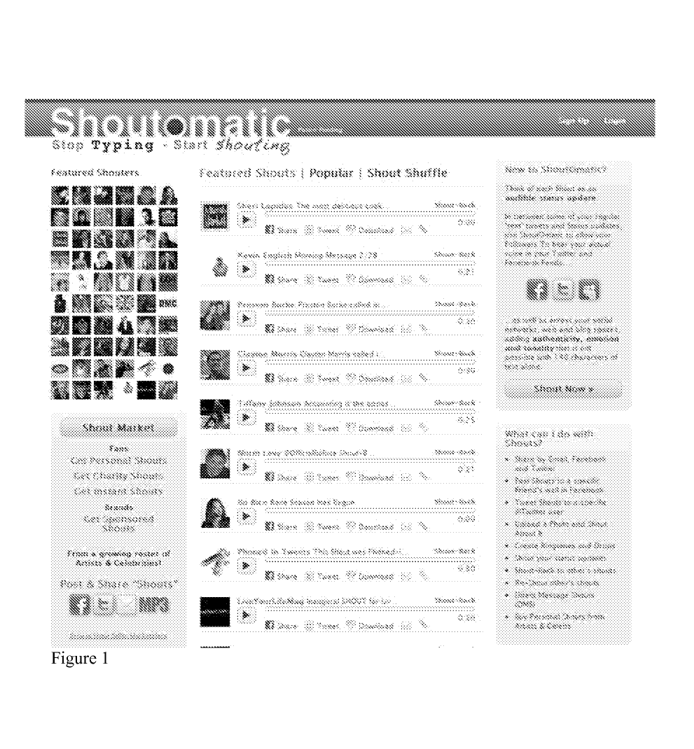

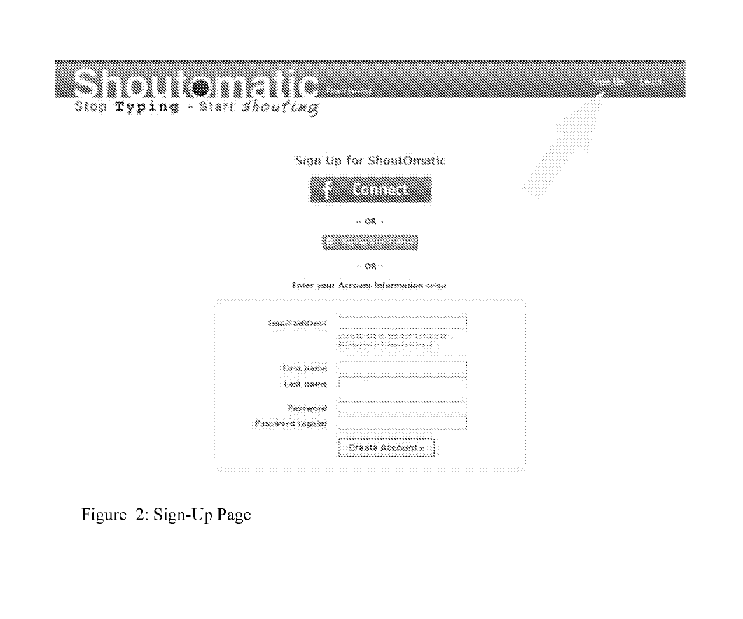

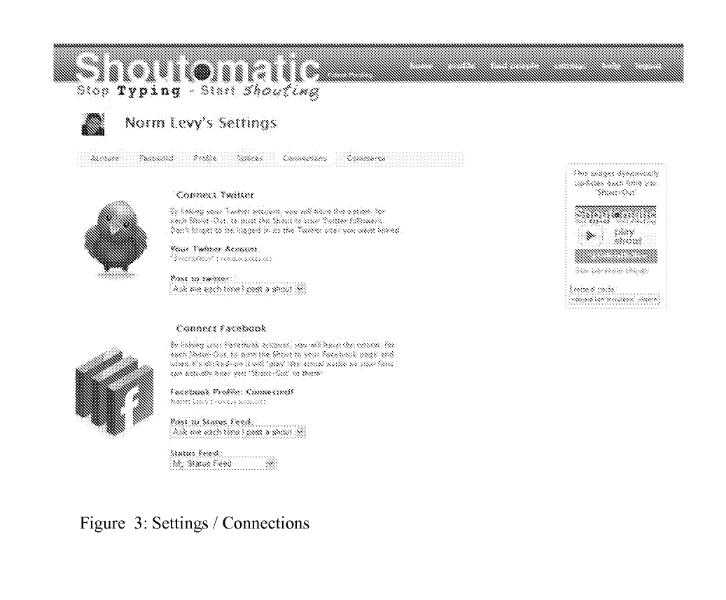

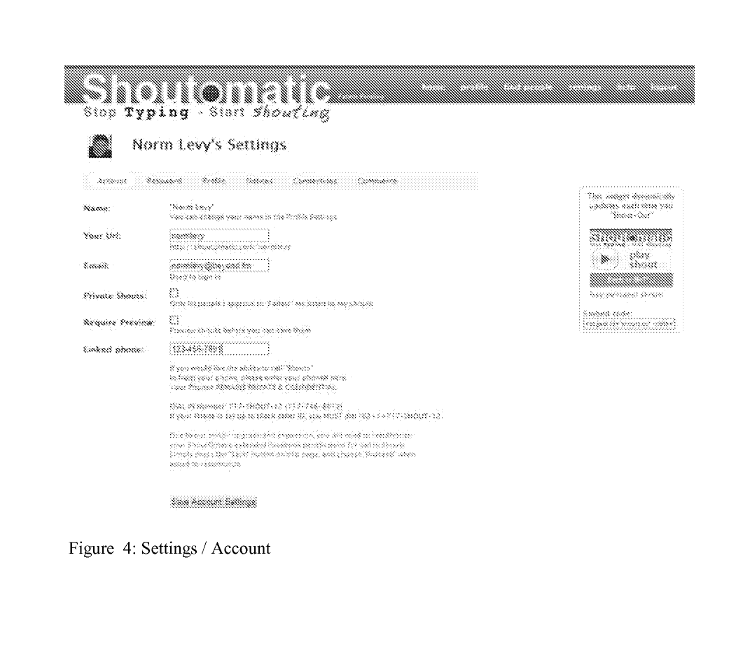

With reference to the figures, the following outline provides a description of several embodiments of the present invention.
FIG. 1: ShoutOmatic before user signs-up or signs-in
   1. Sign-up for ShoutOmatic
      a. Can sign-up with Twitter-connect
      b. Can sign-up with Facebook-connect
      c. Can sign-up with LinkedIn-connect
      d. Can sign-up with an email address and password
FIG. 2: Sign-up Page
   2. “Settings” tab Set-up your ShoutOmatic Profile
      a. “Connections” Settings:
         i. Link your Twitter account to your Shouts get auto-posted to your Twitter time-line
         ii. Link your Facebook account so your Shouts get auto-posted to your Facebook wall
         iii. Link your LinkedIn account so your Shouts get auto-posted to your LinkedIn status update.
FIG. 3: Settings/Connections
   b. “account” Settings
      i. Name: How your name displays in our profile
      ii. Your URL: your custom domain address for ShoutOmatic: http://ShoutOmatic.com/username
      iii. Email address used to sign in and for internal communications
      iv. Privacy option. If you want to only allow people that you “approve” to follow you to hear your Shouts
      v. “Require Preview” option lets you turn “off” the previewing of a recorder Shout before you post to the public (recommend only for experienced Shouters)
      vi. Linked Phone: First time in history user can call in their Tweets and Facebook status updates via their cell phone. Once user enters the phone number they will be calling in Shouts from, they simply call 717-SHOUT-12 (717-746-8812) and their Shouts automatically post to their Twitter, Facebook, and LinkedIn.
FIG. 4: Settings/Account
   vii. When Governments SHUTS DOWN Internet access to their citizens, the citizens can still get their message(s) to Twitter! If user does NOT have Internet Access or a ShoutOmatic Account and wants their Voice Message Tweeted for them they simply call Voice Tweets into (001) 717-746-8813 and they AUTOMATICALLY POST to Twitter for

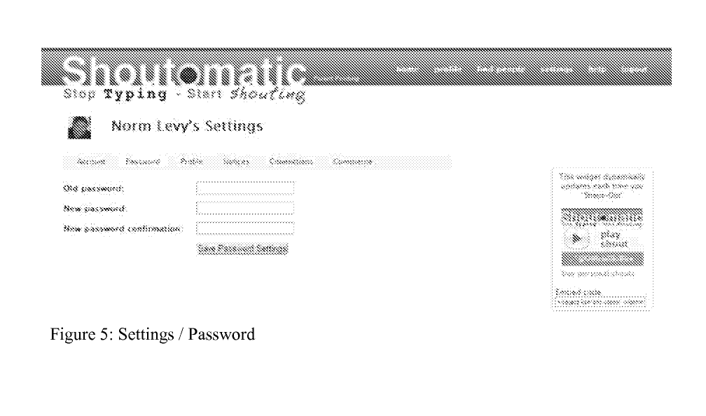

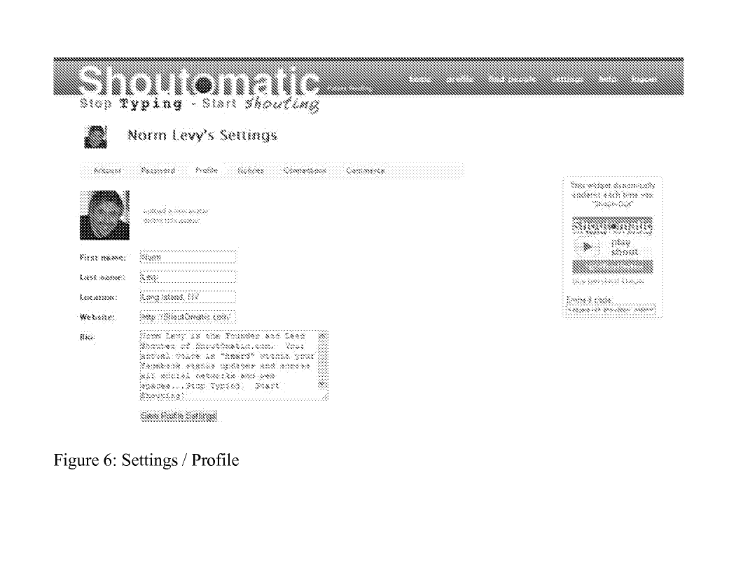

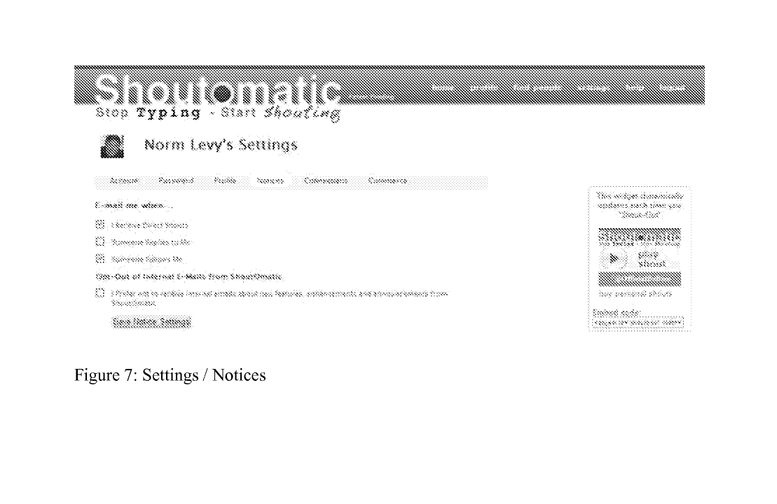

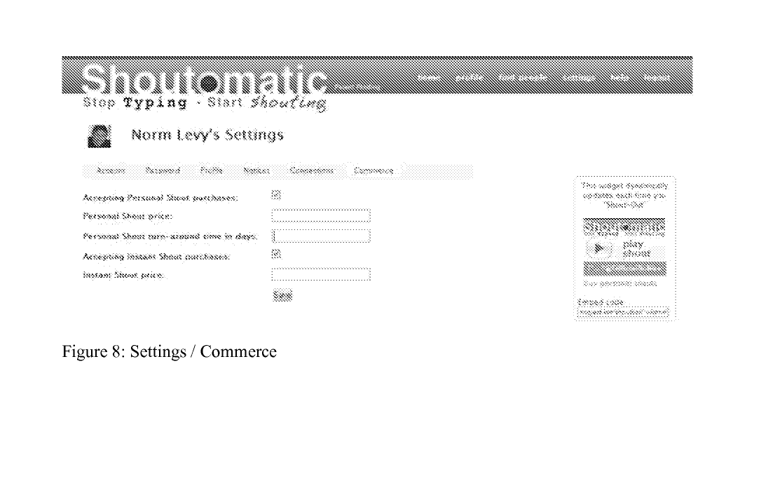

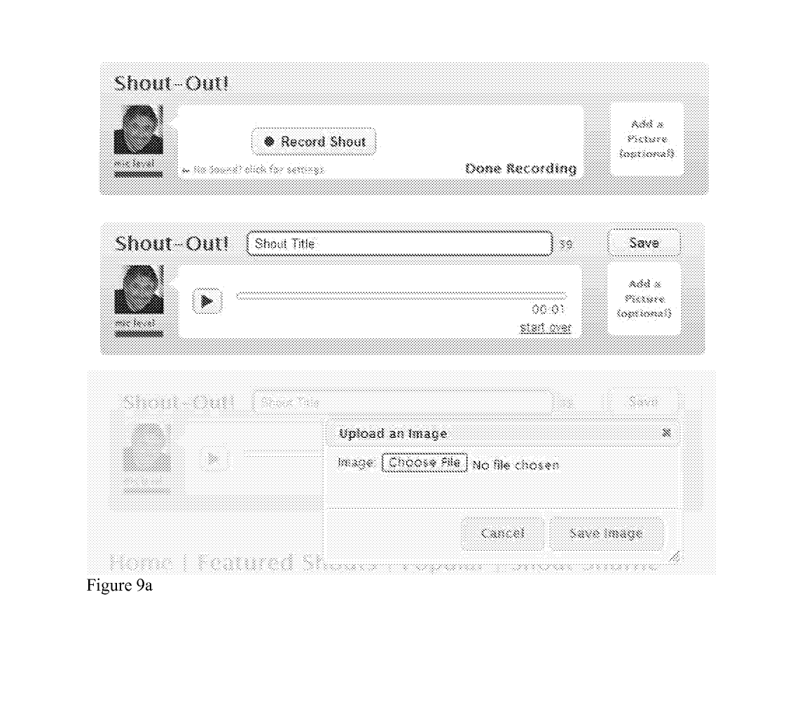

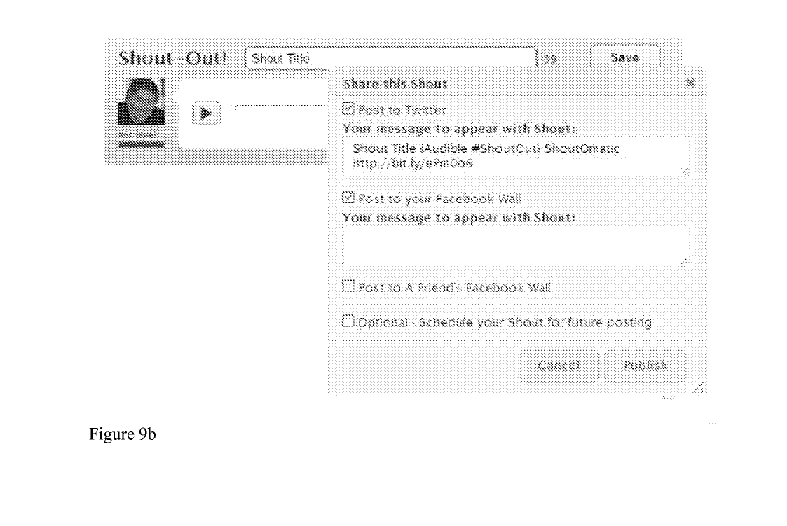

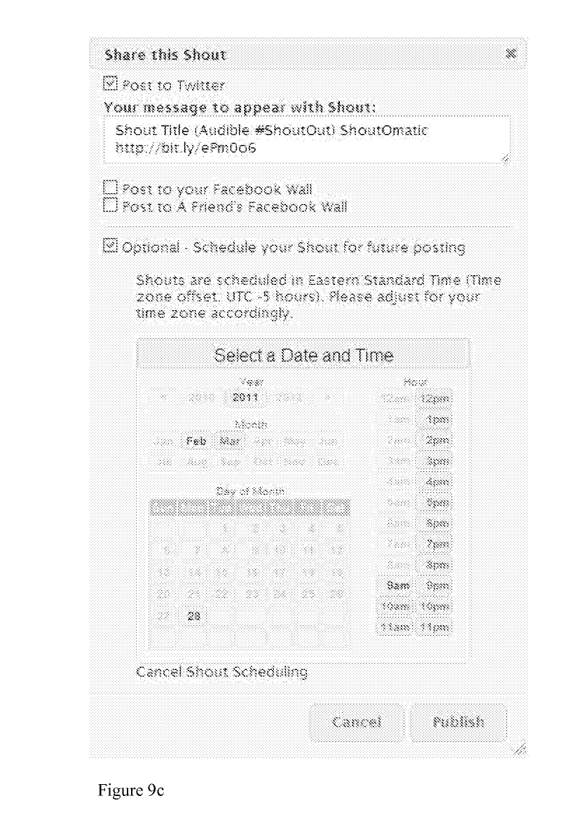

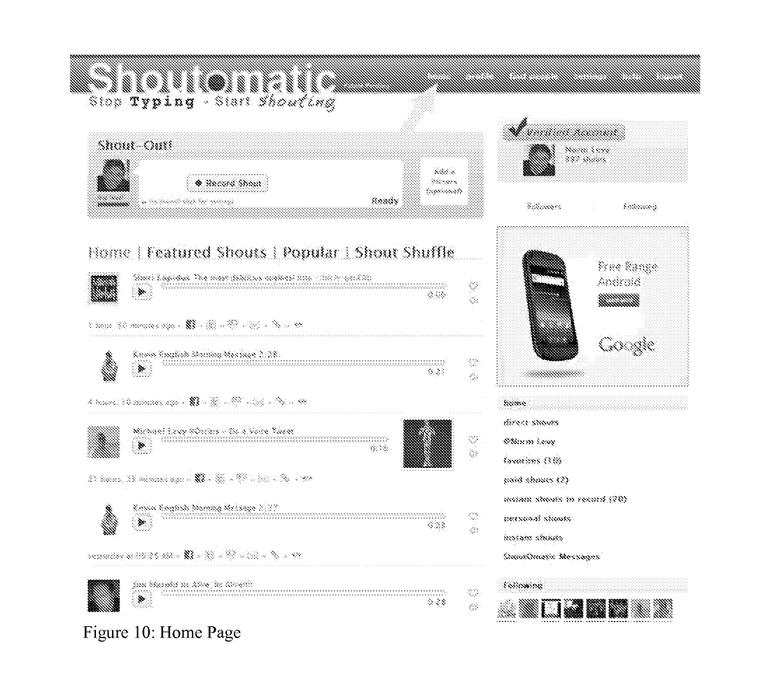

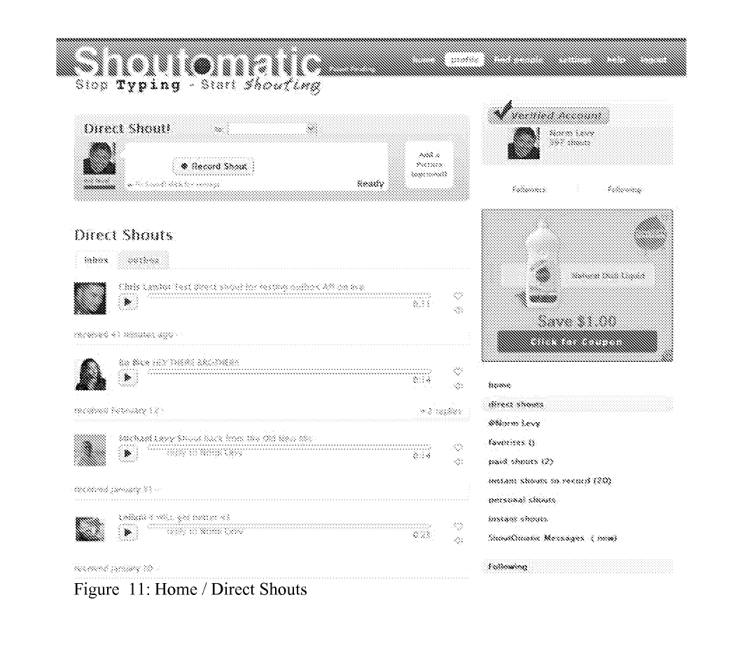

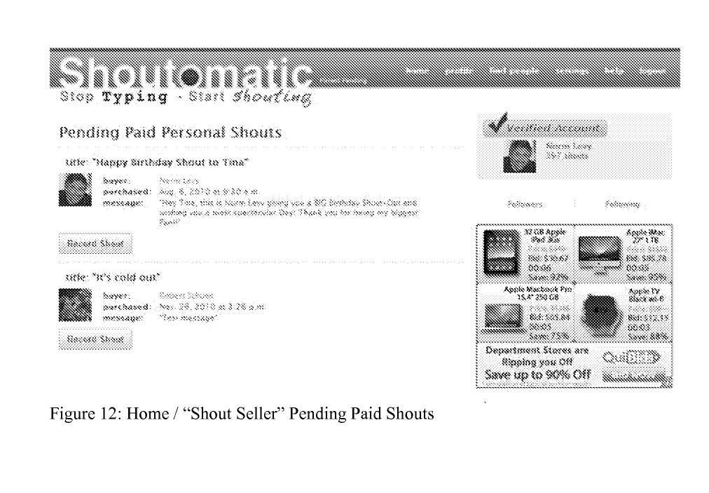

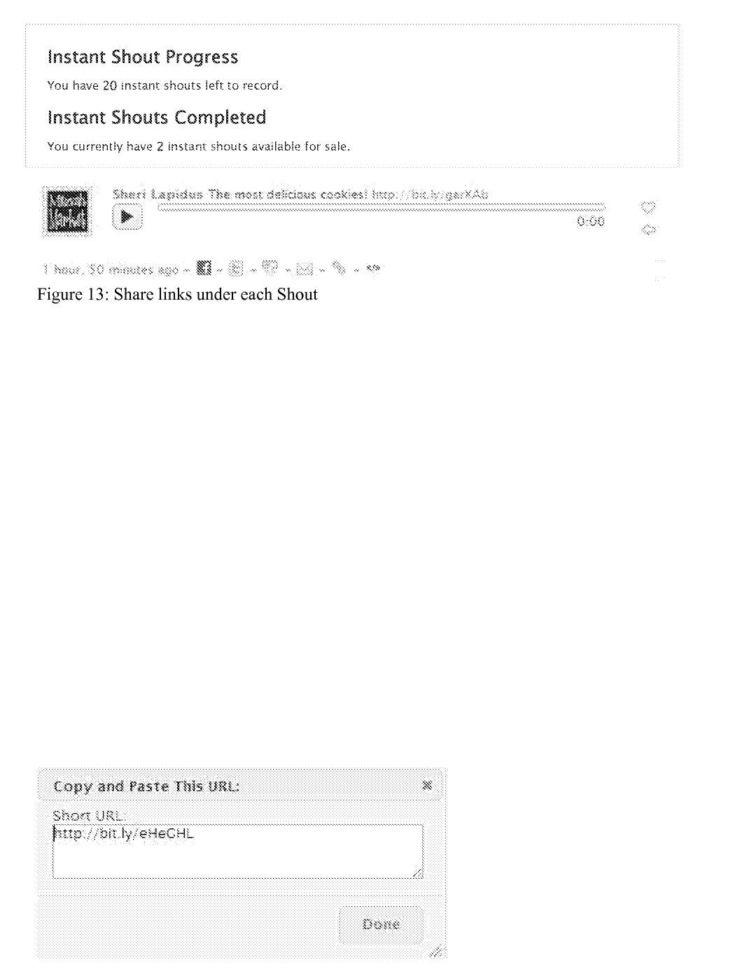

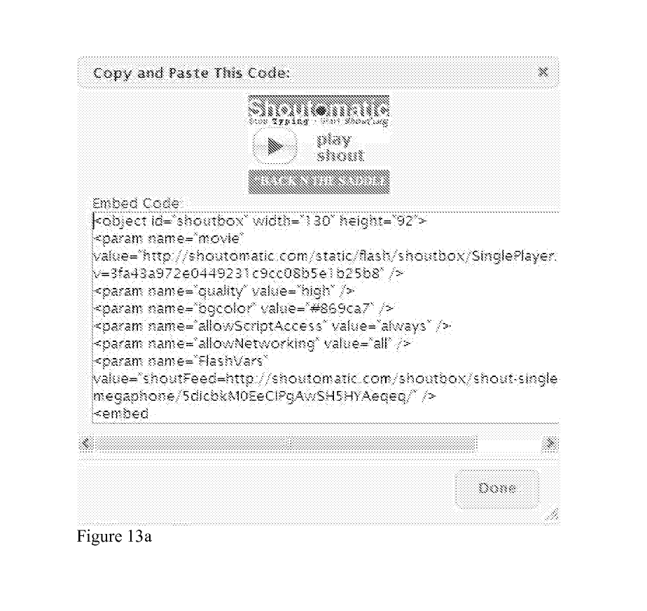

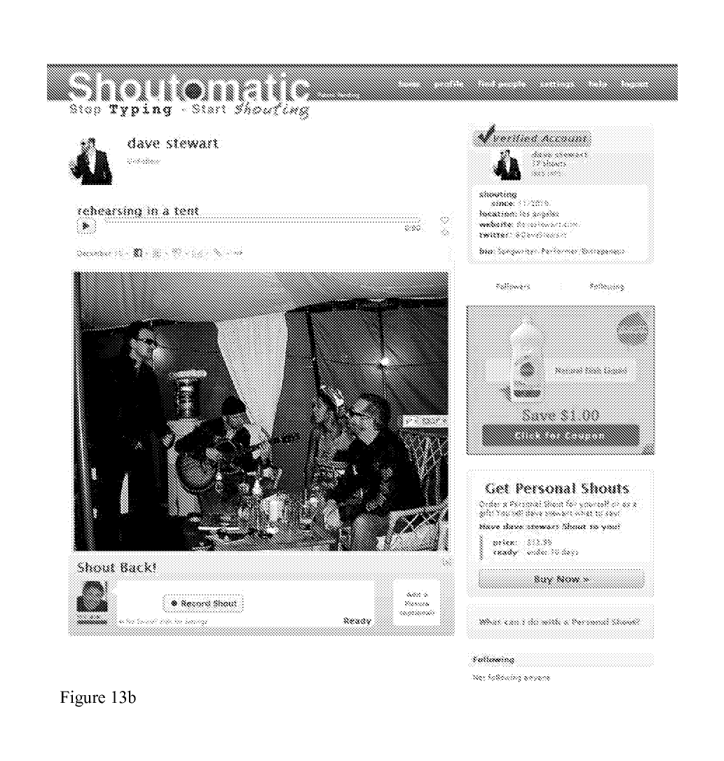

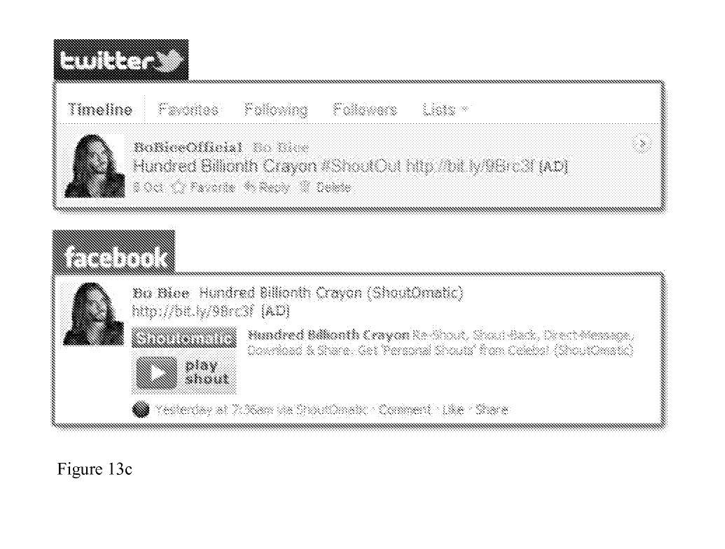

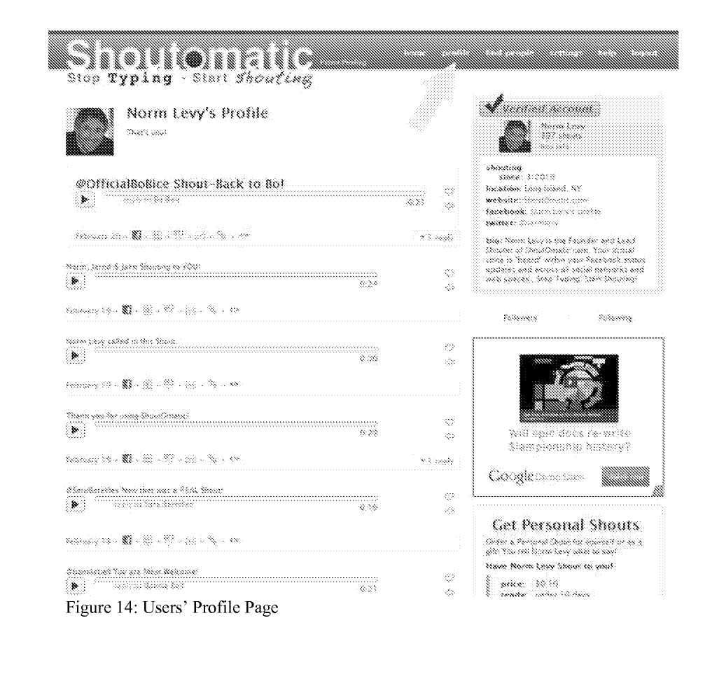

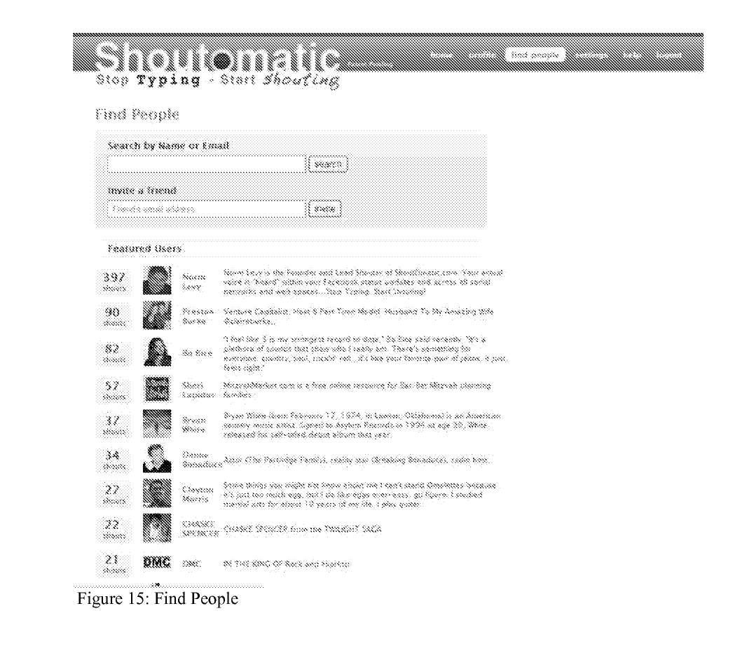

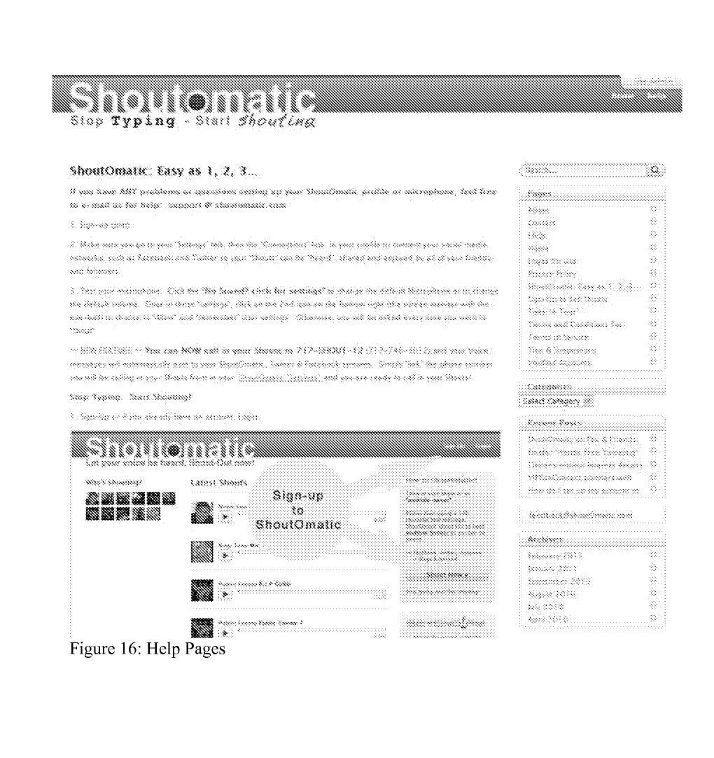

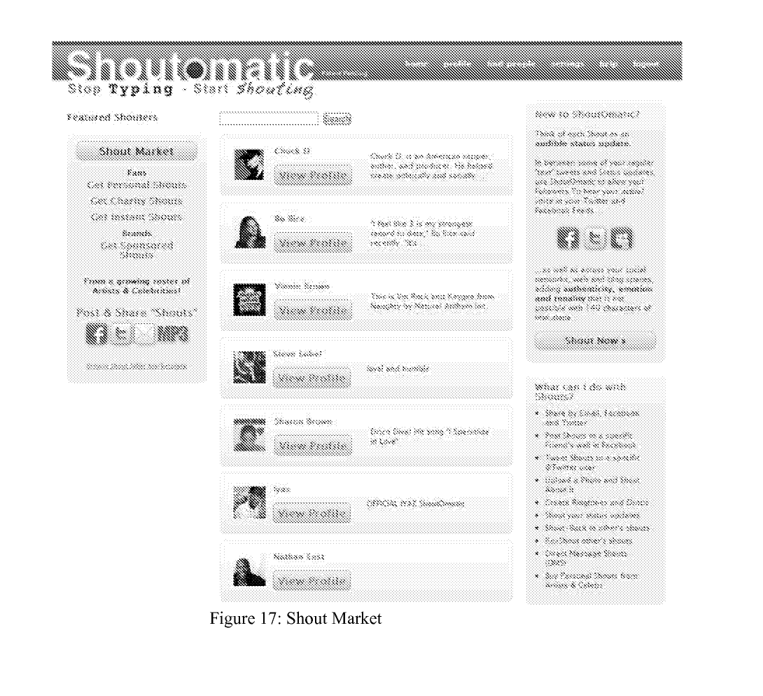

EVERYONE to HEAR their actual voice! While Internet access is being shut down by such governments such as Egypt, Bahrain, Yemen, Libya, China, etc, ShoutOmatic allows citizens to Post Tweets without the need for computer, internet or apps! Just Call US (001)-717-746-9913 and the Voice Tweet goes directly to Twitter via @PhonedInTweets and Facebook
c. “Password” Settings
   i. Allows you to change your ShoutOmatic account password as often as you wish
FIG. 5: Settings/Password
   d. “Profile” Settings
      i. Avatar/Profile Photo: upload a new profile photo of yourself. When you use Twitter or Facebook connect and you have no avatar yet, ShoutOmatic grabs your avatar photo from Twitter or Facebook
      ii. First Name
      iii. Last Name
      iv. Location
      v. Web site
      vi. Bio
      vii. Your Twitter and Facebook links will appear automatically in your profile if you linked those accounts
FIG. 6: Settings/Profile
   e. “Notices” Settings (allows user to choose the notification they would like to receive)
      i. E-mail me when I Receive Direct Shouts
      ii. E-mail me when Someone Replies to Me
      iii. E-mail me when Some Follows Me
      iv. Opt-Out of Internet E-mails
FIG. 7: Settings/Notices
   f. “Commerce” Settings (This settings section ONLY appears if you are Approved for Commerce)
      i. Accepting “Personal Shout” Purchases (can toggle off and on)
      ii. “Personal Shout” Price (can change at any time)
      iii. “Personal Shout” turn-around time; in days
      iv. Accepting “Instant Shout” Purchases
      v. “Instant Shout” Price
FIG. 8: Settings/Commerce
FIGS. 9a, 9b, 9c
   3. Your “Home” tab
      a. Your HOME tab is where you Record your Shouts
         i. Record your audible Shout 1. Microphone settings
         ii. Upload a Photo with each Shout 1. Upload Photo from your computer 2. Snap a photo from your webcam
         iii. Add TEXT to each shout
         iv. SAVE: Then Dialogue Box opens for you to chose to Post Shout to your Twitter and/or Facebook and/or to a Friends' Facebook Wall 1. And you can Choose to Schedule your Shouts to Post to your social networks at a later time.
      b. Your HOME tab is where ALL of the Shouts will appear from all of the People your “Follow”
      c. View & Listen to “Featured Shouts”, “Popular Shouts” and “Shout Shuffle”
      d. Followers (Shows all ShoutOmatic Users that have elected to Follow you)
         i. Your Shouts appear and can be listened to in the HOME stream of all Users that Follow you
      e. Following (Shows all ShoutOmatic Users that you elected to Follow)
         i. All Users that your Follow, their Shouts will appear in your Home stream
FIG. 10: Home Page
   f. LINKS: On the RIGHT Column
      i. Direct Shouts (displays all Direct Shouts to User)
FIG. 11: Home/Direct Shouts
   ii. @UserName (displays all replies User's Shouts)
   iii. Favorites (displays all of the Shouts you select as a “Favorite”)
   iv. Paid Shouts (displays all of the open orders you have for “Personal Shouts” if you have Commerce turned “on.”
FIG. 12: Home/“Shout Seller” Pending Paid Shouts
   v. Instant Shouts to Record (displays all Instant Shouts that need to be Recorded if your Commerce is turned “on” to sell Instant Shouts).
   vi. Personal Shouts (display all Personal Shouts that the user Ordered from Celebrities).
   vii. Instant Shouts (displays all Instant Shouts that the user ordered from celebrities).
g. Share links under each Shout
FIGS. 13, 13a, 13b and 13c: Share links under each Shout
   i. Share on Facebook (press this icon to post Shout to your Facebook wall or to a friend's Facebook wall)
   ii. Share on Twitter (press this icon to post Shout to your Twitter feed as well as to a friend's Twitter feed)
   iii. Share on LinkedIn (press this icon to post Shout to your Twitter feed as well as to a friend's LinkedIn status update)
   iv. Download as an MP3
   v. E-mail to friend (email Shout to play on a mobile device, email Shout to DJ to play at a party, etc.)
   vi. Short URL: Each Shout gets a shortened URL for easy sharing.
   vii. Each Shout gets its own “Player Widget” embed code that allows Shout to be played anywhere on the internet; blogs, web sites, etc.
   viii. Shout-Back (reply to someone's Shout).
   ix. Favorite (pressing the “heart” adds that Shout to your Favorites).
h. Each Shout gets its own “landing” page on ShoutOmatic, as well as on mobile devices such as a smart phone, a tablet computer, or other applicable device.
i. This is what a Shout looks like in Twitter
j. This is what a Shout looks like in Facebook.
k. This is what a Shout looks like in LinkedIn.
4. “Profile” tab
   a. This is the Users' only stream of Shouts (time-line)
   b. The Users' Profile is what appears to other users
      i. User information, personal links and bio
      ii. If the user was a celebrity or personality with Commerce turned “on” visitors to this profile would see
         1. Verified Account info
         2. Personal Shouts—for sale
         3. Instant Shouts—for sale
         4. Sponsored Shouts—for sale to “brands”
      iii. Shows User's Followers
      iv. Shows who User is Following
FIG. 14: Users' Profile Page
   5. “Find People” tab
      a. Search for other Shouters
      b. Search for celebrity Shouters
      c. Invite friends to Shout
         i. If a search comes up with no results, you can invite that person automatically.
FIG. 15: Find People
   6. “Help” tab
      a. This section includes Tutorials, FAQs, How To's, News, Blogs.
   7. “Log Out” tab
      a. Logs User out of ShoutOmatic
   8. Shout-Market
      a. All celebrities and personalities who request to have their

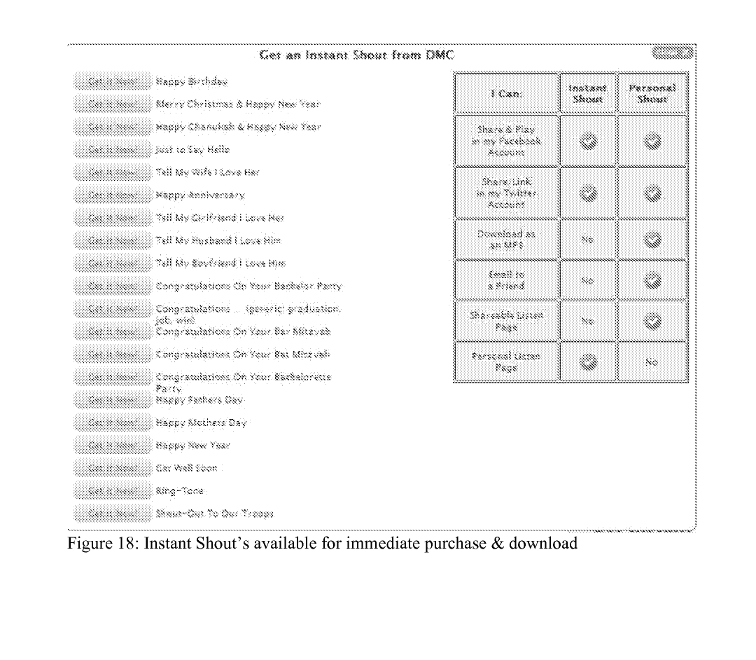

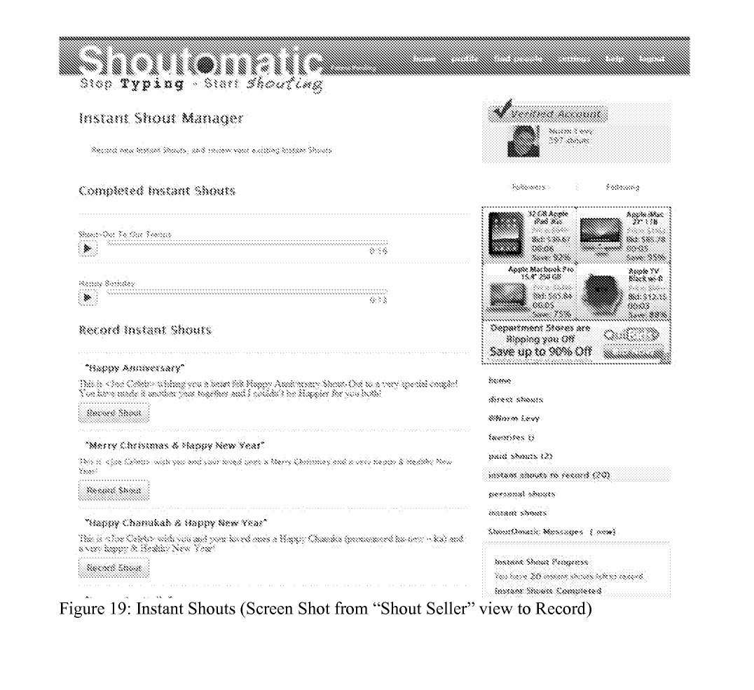

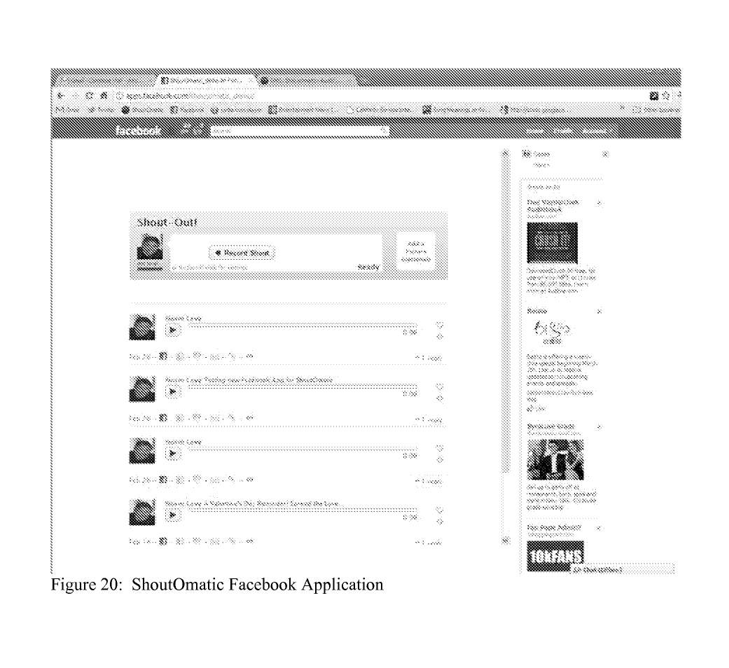

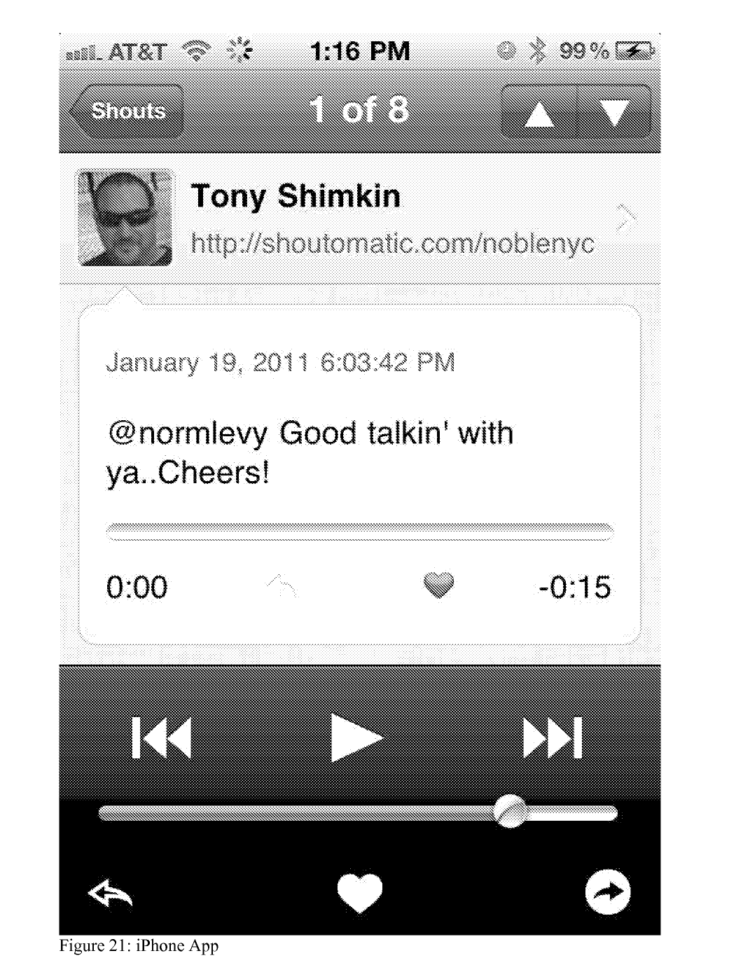

Commerce turned “On” have 4 levels of Shout Commerce.
i. “Personal Shouts”—Customer gets to tell the celebrity what to Shout in a person, custom audible, digital message for the user or directed to another person as a gift. 1. Can share the Personal Shout in all social networks, this includes: Facebook, Twitter, Myspace, blogs, etc. 2. Can listen to the Shout on a mobile device. 3. Can use the Shout as a ringtone on most mobile devices (subject to the capabilities of the specific device). 4. Can order Shouts as a gift. 5. Permanent page of Shout on ShoutOmatic to enjoy and share the Shout.
FIG. 18: Instant Shout's available for immediate purchase & download.
FIG. 19: Instant Shouts (Screen Shot from “Shout Seller's” point of view to Record)
Facebook App:
User does not have to leave Facebook in order to Record, Broadcast and
Listen to Shouts. Everything can be done within Facebook.
FIG. 20: ShoutOmatic Facebook Application
FIG. 21: iPhone App

### Mobile App:

All Recording (including fulfilling Shout purchase orders), broadcasting, and listening functionality is available on mobile platforms such as iPhone, Droid and Ipad. Recording within Shout mobile app is digitally recorded.

### Mobile Extreme:

Any ShoutOmatic user can call 717-SHOUT-12 from their phone and their Shouts will be automatically posted to their Twitter, Facebook, LinkedIn, or website feeds. Additionally their message is immediately accessible by via associated QR codes on printed media or dynamic media. Any person that has internet access taken away can still get their message to social networks by simply calling their Shouts into 717-SHOUT-12 (001-717-746-8813) and their Shouts (Voice Messages) are automatically posted to Twitter and Facebook and made accessible via scanning a QR code on printed media or dynamic media.

The method of having dynamic QR codes assigned for each Shout is as follows: a user records an audio or video message, that message is uploaded to ShoutOmatic, in addition to hosting the file and assigning a URL the server creates a QR code that points to that URL. The QR code becomes available to the user through the ShoutOmatic application or on the website. The user may print or save this QR code for publishing on different media if they choose. Additionally if the user prefers their new recorded message can be automatically placed onto the URL that a prior QR code was assigned, this may or may not require previous recorded messages from being automatically removed from that URL. Alternatively a user may assign times, days, or months when a QR code assigned URL is to be automatically changed, thereby effectively automatically changing what will be recalled when someone scans the QR code with a QR code enabled device. A common way to change the URL is to preset a different URL that the QR code assigned URL should be redirected to upon the time or date set by the user. A user may set a plurality of different times and dates that the QR code assigned URL should change.

ShoutOmatic offers a variety of unique opt-in commerce features. These include Instant Shouts, Personal Shouts, Personal Advice, Charity Shouts and Sponsored Shouts. Instant Shouts are Shouts created by the “Shout Seller” (often a celebrity), where the

“Shout Seller” records a “generic greeting” once and this same Shout is sold over and over again to purchasers. Personal Shouts are Shouts created by the “Shout Seller” (often a celebrity), where the “Shout Seller” records a custom Shout based upon what an individual purchaser wants them to say, this type of Shout is sold only once, it is uniquely given to the purchaser that ordered the Personal Shout. A Personal Advice (Shout) is when a “Shout Seller” is asked a particular question by a purchaser and the response to the question is recorded by the “Shout Seller.” A Charity Shout is when a portion of sales revenue from a Shout is given to charity. Sponsored Shouts are shouts sponsored by brands where a brand pays the “Shout Seller” for a Shout that contains a voice endorsement that gets posted to the Shout Seller's social media accounts such as Twitter and Facebook. Sponsored Shouts are ideally used in conjunction with celebrities and popular social influencers. ShoutOmatic also shares ad revenue with some popular users.

The exact method of fulfilling personal shout orders is as follows a celebrity user opts-in to offer personalized, custom shouts available to other users. A celebrity user is defined as a popular user of the ShoutOmatic website. In the celebrity dashboard the celebrity chooses the price, turn-around time and the quantity of Shouts to be sold. If the number of Shouts to be sold reaches zero then no more orders can be accepted until the celebrity enters a new quantity. When celebrities turn their commerce “on” other users see “Get Personal Shouts” on the celebrities profile. When the celebrity sets their commerce to “on” they may choose to receive the proceeds from the sales or donate it directly to charity. “PersonalShouts” can be ordered from celebrities, consultants or influencers.

When a user buys a PersonalShout from a celebrity the first step is to write up to a 30 second script for the celebrity to recite and record. The celebrity is not obligated to read the script verbatim. The celebrity can reject any order for any reason. The purchasing user has the option of including a personal greeting card that will accompany the order by checking off a box that says “Gift Card”. After the user presses the “Next” button they are brought to a page hosted by our credit card merchant. The user then submits their credit card information, their card is charged and the money is placed on hold and served for the order for up to 7 days. If the order is not fulfilled within 7 days the credit card charge is automatically voided.

After the credit card is charged the celebrity gets an email notice of the pending order with the proper link to take them directly to fulfill the order and simultaneously the order appears in the celebrities “Pending Order” tab in their ShoutOmatic profile, both on the web and their mobile application. The purchasing user also receives an email confirmation. The celebrity opens their “Pending Orders” tab they see the new order and may press “Fulfill Order”. When pressed the purchasing user's script is displayed and a recording button appears under the script. Upon reading the script the celebrity may opt to either accept the order or to reject the order. If the order is rejected it will be cancelled, if the order is accepted the celebrity will fulfill the order.

The celebrity can record and rerecord the script until they are happy with the results. Once they are happy with the recording they have created they hit “Submit.” Upon hitting “Submit” the order is removed from the Celebrity's “Pending Orders” and moved to the “Completed Orders” tab. An email is sent to the administrators notifying them that an order has been placed into their “Pending Approval” tab. The administrators who review the order and either approve or reject the order. If the recording is rejected by the administrators then the order will be moved to the celebrity's “Pending Orders” tab. If the recording is approved by the administrators then the purchasing user receives a notice that the order has been fulfilled and is ready to be listened to in their ShoutOmatic profile, via the website or the mobile application.

This invention provides a client, who is a particular user, a interface device that enables the client to record a message by calling a specified telephone number where the user then uses the telephone interface to record message. The client is linked to their account through either a pin code system or through caller identification based upon the phone number they are calling from. A particular user is defined as an individual or company that has a registered account with ShoutOmatic, this account could have been registered either through the website or the application. An interface device is a device that allows the user to use the provided user interface. The user interface is either the ShoutOmatic telephone system, the ShoutOmatic application for mobile devices or the ShoutOmatic website. The user interface on a telephone is an audio interface, that facilitates the recording of an audio message. The user interface for computers, or mobile devices can be both audio and visual in nature. A user interface on a computer may facilitate the recording of an audio or video message. Examples of interface devices are telephones, computers, and mobile devices. Mobile devices are defined as cellular phones, smart phones, tablet computers, and laptop computers. This message may be an audio recording. It is contemplated however that future telephone communication may be video, and therefore the recorded message may be a video recording. Additionally there is a mobile device interface that allows a client to record a message on a mobile device such as a smart phone, tablet or laptop computer. A client may also record a message on a computer. The recorded message on a mobile device or computer may be an audio recording or it is contemplated that it may be expanded to include video recordings.

After recording the message the message is then automatically distributed to a plurality of communications links. A communications link is an electronic platform capable of facilitating communication with another person. Some examples of communications links are websites, blogs, mobile applications, smart phones, computers, cellular phones or social media outlets. Depending on how the user chose to distribute the message to one or a plurality of communications links non-clients or clients may be able access the recorded message. A non-client is defined as any person or company who does not have a registered ShoutOmatic account. When the message is recorded a quick response (QR) code is automatically assigned to the message. The assigned QR code links to either a uniform resource locator (URL) or a file on a server. The URL's automatically changed upon a temporal occurrence. A temporal occurrence is defined as a specific day of the week, day of the month, time, or time and date that is selected by a user or through randomized selection. To automatically change a URL's content means to alter some aspect of the URL's code through an prescheduled automatic process. The QR code can be used by scanning or photographing it by QR code enabled devices.

When the QR code is scanned or photographed by QR code enabled devices it accesses a URL or file on a server which the QR code has been assigned. The message may be assigned a QR code, which was previously assigned to a prior message. If the recording client chooses they may enable the commerce function of ShoutOmatic and the messages they record will be available for purchase by another user or by a plurality of users.

Alternatively a method consisting of providing to a client a user interface on a interface device that enables said client to record a message. Wherein said interface device is a mobile device. Wherein the client is a particular user. Wherein said message is automatically assigned a quick response (QR) code. Wherein said QR code is to a uniform resource locator (URL). Wherein said message is then automatically distributed to a plurality of communications links, enabling non-clients or clients to access said message. Additionally the message can be available for purchase by a plurality of other users through a marketplace. A marketplace is defined as an area of a website or application that allows users to choose and pay for a recorded audio or video messages

What is claimed is:

1. A method comprising:
providing to a client a user interface that enables said client to record a new audio message using a mobile device, wherein the client is a particular user; wherein said message is then automatically distributed to a plurality of communications links, enabling non-clients or clients to access said message.

2. The method as recited in claim 1, wherein said communications links are websites.

3. The method as recited in claim 1, wherein said communications links are mobile devices.

4. The method as recited in claim 1, wherein said message is automatically assigned a quick response (QR) code.

5. The method as recited in claim 1, wherein said message is reassigned a QR code, which was previously assigned to a prior message.

6. The method as recited in claim 4, wherein a buying user can commission a second user to create a custom message for purchase by said buying user.

7. The method as recited in claim 4, wherein said message is available for purchase by a plurality of users.

8. A method comprising:
providing to a client a user interface that enables said client to record a new video message using a mobile device, wherein the client is a particular user; wherein said message is then automatically distributed to a plurality of communications links, enabling non-clients or clients to access said message.

9. The method as recited in claim 8, wherein said message is automatically assigned a QR code, wherein said QR code is automatically assigned to a uniform resource locator (URL).

10. The method as recited in claim 8, wherein said message is reassigned a QR code, which was previously assigned to a prior message.

11. The method as recited in claim 9, wherein a buying user can commission a second user to create a custom message for purchase by said buying user.

12. The method as recited in claim 9, wherein said message is available for purchase by a plurality of other users.

13. The method as recited in claim 9, wherein the content of said URL automatically changes at predetermined specific date and time.

14. A method of assigning QR codes comprising:
a single step process of automatically reassigning a QR code to a uniform resource locator (URL) when a file is uploaded from a mobile device to the internet, wherein said QR code was previously assigned to another URL.

15. The method as recited in claim 14, wherein said file is an audio file.

16. The method as recited in claim 14, wherein said file is a video file.

17. The method as recited in claim 14, wherein said URL is for a multimedia file.

18. The method as recited in claim 14, wherein the content of said URL automatically changes at predetermined specific date and time.
